(19) United States
(12) Patent Application Publication
(10) Pub. No.: US 2008/0148165 A1
(43) Pub. Date: Jun. 19, 2008

(54) System and method of providing assistance over a network

(75) Inventor: Gary Zalewski, Oakland, CA (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Computer Entertainment America Inc., Foster City, CA (US)

(21) Appl. No.: 11/986,436

(22) Filed: Nov. 21, 2007

Related U.S. Application Data
(60) Provisional application No. 60/860,938, filed on Nov. 22, 2006.
(60) Provisional application No. 60/860,937, filed on Nov. 22, 2006.
(60) Provisional application No. 60/860,936, filed on Nov. 22, 2006.

(51) Int. Cl. G06F 3/048

(52) U.S. Cl. 715/764

(57) ABSTRACT

A system and method relating to receiving manipulation data from a controller and a displaying a graphic representing the manipulation and the controller on a first display and transmitting the manipulation data for substantially-simultaneous on a second display remote from the first display.

### CROSS-REFERENCE TO RELATED APPLICATIONS

This application claims the benefit of the filing date of U.S. Provisional Patent Application Nos. 60/860,936, 60/860,937 and 60/860,938, all filed Nov. 22, 2006, the disclosures of which are all hereby incorporated herein by reference.

### BACKGROUND OF THE INVENTION

Video and electronic games have become increasingly complex over time. Game characters are capable of executing more maneuvers, and game controllers have incorporated more controls. For example, aside from including more buttons and joysticks, many game controllers may be tilted, turned, raised, or lowered in order to accomplish a particular move. Correspondingly, it would help users if they could increase their knowledge of controller manipulation.

Prior games have offered in-game instructions regarding which buttons to press, or the direction to push a joystick, in order to accomplish particular functions or moves. These games may include a graphic display of a controller. However, these games fall short of tutoring a user on the best way to use a controller.

The present invention is directed to this need.

### SUMMARY OF THE INVENTION

In one aspect, the prevent invention provides a method comprising: receiving controller manipulation data identifying manipulation of a controller, displaying a controller graphic representing the controller on a first display, the controller graphic visually indicating the manipulation, displaying, on the first display, other data changed in response to the manipulation of the controller, and transmitting the controller manipulation data for substantially-simultaneous display of a controller graphic on a second display remote from the first display.

### BRIEF DESCRIPTION OF THE DRAWINGS

FIG. 1 illustrates a system in accordance with an aspect of the invention.

FIG. 2 illustrates an arrangement of a game data and a controller graphic in accordance with an aspect of the invention.

FIG. 3 illustrates an arrangement of a game data and a controller graphic in accordance with an aspect of the invention, and an arrangement of game data without a controller graphic.

FIG. 4 illustrates an arrangement of a game data, a controller graphic and other information in accordance with an aspect of the invention.

FIG. 5 illustrates controller manipulation data and character position data in accordance with an aspect of the invention.

FIG. 6 illustrates a system operating in accordance with an aspect of the invention.

FIG. 7 illustrates an operation in accordance with an aspect of the invention.

FIG. 8 illustrates a system operating in accordance with an aspect of the invention in accordance with a yaw position of the controller.

FIG. 9 illustrates a system operating in accordance with an aspect of the invention in accordance with another yaw position of the controller.

FIG. 10 illustrates a system operating in accordance with an aspect of the invention relating to tutors and students.

FIG. 11 illustrates a system in accordance with an aspect of the invention relating to tutors and students.

FIG. 12 illustrates a system operating in accordance with an aspect of the invention relating to tutors and students.

### DETAILED DESCRIPTION

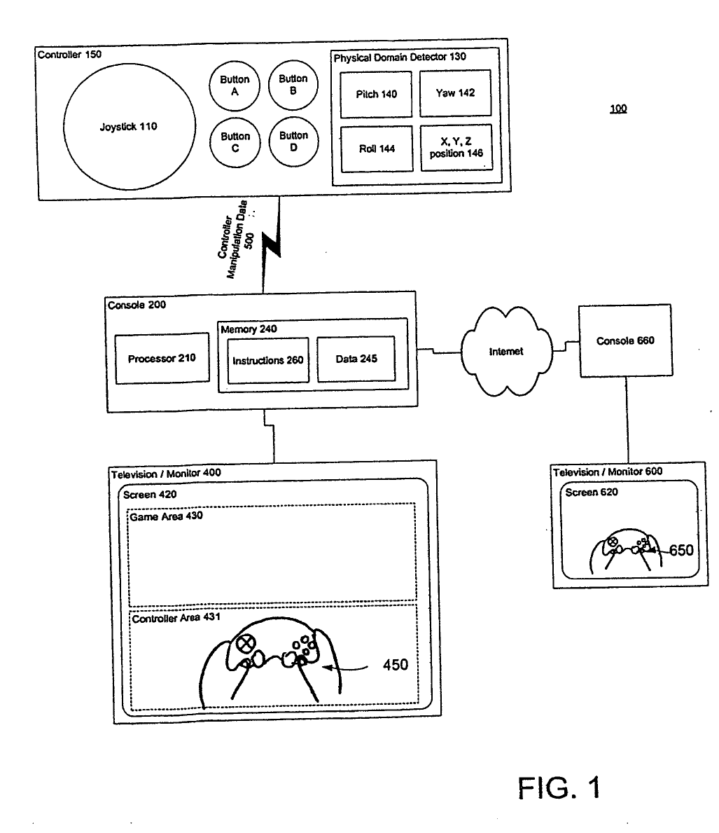

FIG. 1 shows a system in accordance with one aspect of the invention. A controller 150 is electrically connected to a first console 200, which is further connected to a first monitor 400. The first console 200 may be linked to a second console 660, which is electrically connected to a second monitor 600.

The console 200 may be a game console, such as Sony PlayStation®, and include a processor 210 and a memory 240. The memory stores instructions 260 and data 245. Data 245 is retrieved, manipulated or stored by the processor. The memory may be of any type capable of storing information accessible by the processor; by way of example, hard-drives, ROM, RAM, CD-ROM, DVD, write-capable memories, and read-only memories.

The instructions 160 may comprise any set of instructions to be executed directly (e.g., machine code) or indirectly (e.g., scripts) by the processor. The terms “instructions,” “steps” and “programs” may be used interchangeably herein. The functions, methods and routines of the program in accordance with the present invention are explained in more detail below.

Instructions in accordance with the present invention may be stored on the console as routines and called either called by game-specific instructions or function as middleware which is invisible to the game-specific instructions. Alternatively, the present invention may be implemented in the game-specific instructions.

Data 245 may be retrieved, stored or modified by processor 210 in accordance with the instructions 260. The data may be stored in any manner known to those of ordinary skill in the art such as in computer registers, in records contained in tables and relational databases, or in XML files. The data may also be formatted in any computer readable format such as, but not limited to, binary values, ASCII or EBCDIC (Extended Binary-Coded Decimal Interchange Code). Moreover, any information sufficient to identify the relevant data may be stored, such as descriptive text, proprietary codes, pointers, or information which is used by a function to calculate the relevant data.

Although the processor and memory are functionally illustrated in FIG. 1 as within the same block, it will be understood by those of ordinary skill in the art that the processor and memory may actually comprise multiple processors and memories that may or may not be stored within the same physical housing. For example, some of the instructions and data may be stored on a removable CD-ROM and others within a read-only computer chip. Some or all of the instructions and data may be stored in a location physically remote from, yet still accessible by, the processor. Similarly, the processor may actually comprise a collection of processors which may or may not operate in parallel.

As noted above, system 100 may comprise additional components typically found in a game console or computer system such as other user inputs (e.g., a keyboard, mouse, touch-sensitive screen), microphone, modem (e.g., telephone or cable modem), camera, and all of the components used for connecting these elements to one another. Game console 200 preferably communicates with the Internet via the modem or some other communication component such as a network card.

Instead of a game console, the system may also comprise any user device capable of processing instructions and transmitting data to and from humans or other computers or devices, including general purpose computers, network computers lacking local storage capability, PDA's with modems and Internet-capable or other wireless phones, digital video recorders, video cassette recorders, cable television set-top boxes or consumer electronic devices.

The controller 150 may include a variety of controls. For example, it may include at least one joystick 110 and multiple buttons A, B, C and D. The controller 150 may also include a physical domain detector 130. The physical domain detector 130 may detect changes in position of the controller 150, e.g., if the controller 150 is turned, tilted, raised or lowered. According to one aspect of the present invention, the physical domain detector 130 may have a separate component to detect each type of position change. For example, pitch component 140 may detect an upwards or downwards tilt of a front end of the controller 150, whereas yaw component 142 detects rotation of the controller 150 around a vertical axis, and roll component 144 detects when one side of the controller 150 is raised or lowered with respect to another side. Further, X-Y-Z position component 146 may detect the distance of the detector's center from some reference point, such as its distance from the console 200 in the X, Y and Z directions. Methods of detecting the physical position and orientation of a controller are described in U.S. patent application Ser. No. 11/382,032, the disclosure of which is hereby incorporated by reference.

As a user manipulates the controller 150, manipulation data 500 relating thereto is transmitted to the console 200. For example, the controller may transmit the state of the joystick 110 and buttons A-D as well as the orientation and position of the controller 150 in the physical domain, such as its current X-Y-Z position, pitch, yaw and roll.

The controller manipulation data may be received or determined by the console 200 in a number of ways. For example, the controller manipulation data 500 may be received from controller 150 and stored in real-time, e.g., as the controller 150 is being manipulated by the user. The controller manipulation data may also have been pre-stored in memory 240, such as being written or captured by a game programmer and stored among the other data in a game disk inserted in console 200. Some or all of the controller manipulation data 500 may be determined at the console 200, which may occur, by way of example, when the console determines the controller's X, Y and Z position by using a camera attached to the console which tracks the physical position of the controller 150. Alternatively, the controller manipulation data may be received from another console or node of a network.

The controller manipulation data may be encoded in any number of ways. For example, the position of the controller 150 in the physical domain (e.g., height in the Z direction) may be encoded as absolute or relative values as a function of set time increments (e.g., 105 mm above the console at t₀, 108 mm above the console at t_{0+5 ms}, 111 mm above the console at t_{0+10 ms}). Alternatively, the position of the controller may be encoded as gestures (e.g., “raised 6 mm over 10 ms”). Storing gestures may be more advantageous than storing positions at time increments because the gestures may take up less memory space. In that regard, the console 200 may receive the controller manipulation data 500 as position data at fixed time increments, determine gestures from such data, and then store the controller manipulation data in the form of gestures as data 245 in memory 240.

Monitor 400 receives its display data from console 200 and includes a screen 420. Preferably, the console's program virtually divides the screen into different areas, such as game area 430 and controller area 431. Game area 430 displays the video game (i.e., characters, background, etc.) being played by a first user.

The controller area 431 displays a controller graphic 450, which provides a graphical view of the manipulation of the controller (such as text, picture or a combination of both). The controller graphic 450 illustrates the various ways in which a controller may be manipulated, such as the movement of its joystick, its buttons, or its orientation and position in the physical domain. Preferably, the controller graphic is an image of hands and a controller performing the user's manipulations of the controller 150. Console 200 renders the controller graphic 450 by decoding the controller manipulation data.

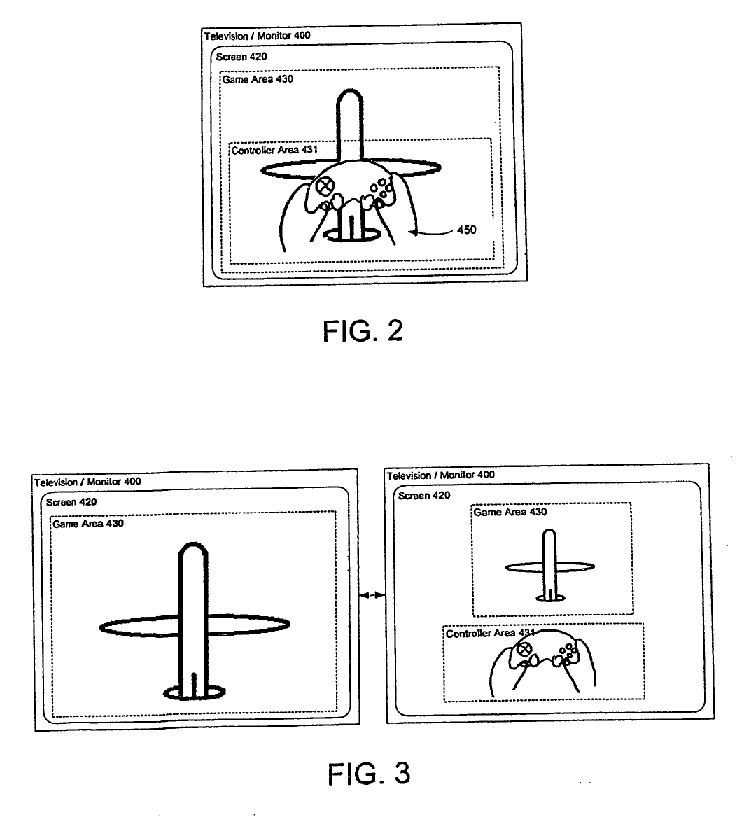

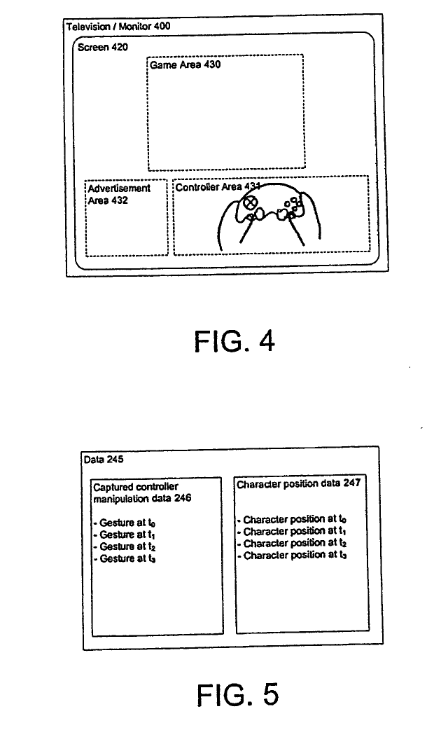

Although the game area 430 is shown in FIG. 1 as being separate from the controller area 431, the controller graphic 450 may be located and formatted in various ways. As shown in FIG. 2, the controller area 431 may partially or completely overlay the game area 430. In such an instance, rather than completely obscuring the game action, the controller graphic may be alpha blended with the game area. As shown in FIG. 3, the controller graphic may be selectively displayed by either a user or a program as well. For example, if the user elects to display the controller graphic, the game area 430 may be shrunk to preserve its original aspect ratio and the controller area 431 displayed adjacent to the game area 430. As shown in FIG. 4, and particularly if there are unused portions of the screen, yet another area 432 of the screen may be devoted to an advertisement or other information. The advertisement may also be seamlessly woven into the game itself, such as by displaying a logo on a character's shirt.

In one aspect of the invention, and as shown in FIG. 1, console 200 is in communication with another console 500. Console 200 and second console 660 may communicate in any manner, such as over the Internet or any other communications medium. Console 660 is also connected to a monitor 600, and displays a controller graphic 450 on a screen 620.

The controller manipulation data may also be sent to any destination for rendering on any display. For example, the controller manipulation data 500 from the controller may be sent to the console 200 for rendering solely on the display directly connected to the console which is directly connected to the controller. Alternatively, the controller manipulation data may also be streamed to another console, such as console 660, for substantially simultaneous real-time display, or later display, at another console.

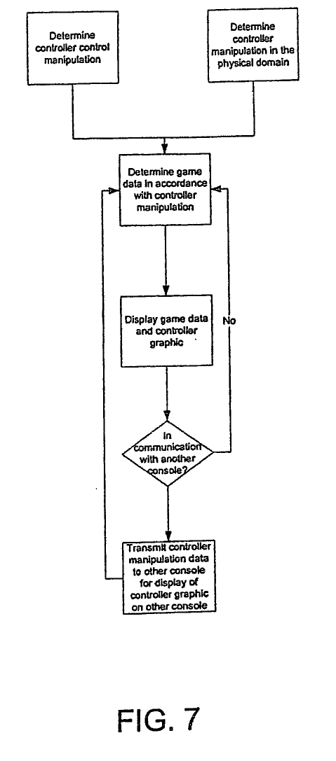

In addition to the operation shown in FIG. 7, Various operations in accordance with a variety of aspects of the invention will now be described. It should be understood that the following operations do not have to be performed in the precise order described below. Rather, various steps can be handled in reverse order or simultaneously.

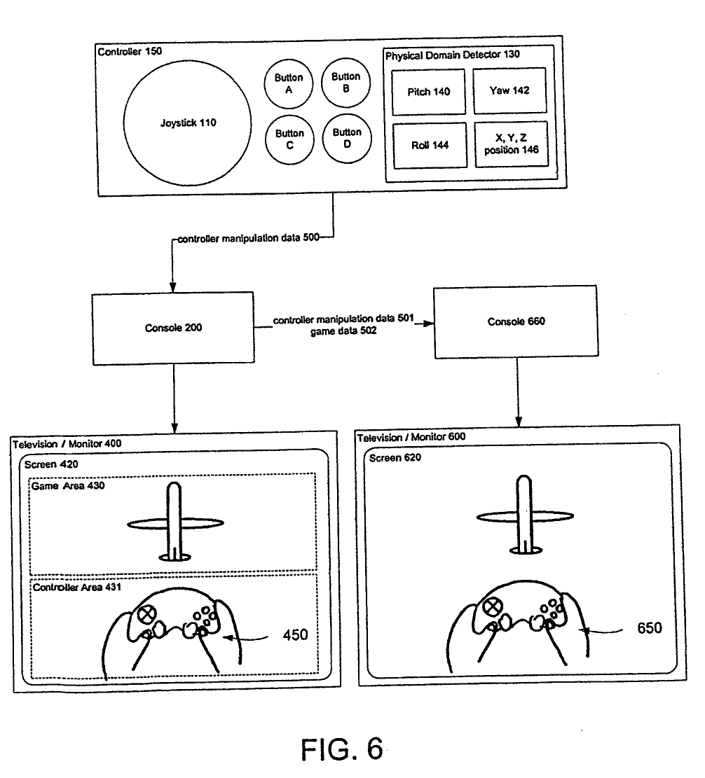

As shown in FIG. 6, a user at console 200 is playing a game involving airplanes. When the user manipulates controller 150, the controller manipulation data 500 is sent to console 200. Console 200, in turn, decodes the controller manipulation data 500 and in-game actions occur in response (e.g., if button A is pushed, fuel is supplied to the engines of the plane character to move the plane forward). The game is visually rendered in game area 430 of the screen 420 of monitor 400. The current state of the controller is simultaneously rendered as controller graphic 450 in controller area 431 of the screen 420. For example, button A on controller graphic 450 may light up when button A of controller 150 is pressed.

At the same time, controller manipulation data 501 is sent from console 200 to console 660. The controller manipulation data 501 sent to console 660 is related to controller manipulation data 500 sent from the controller 150 to console 200. For example, the controller manipulation data 501 may be identical to the controller manipulation data 500. Alternatively, the controller manipulation data 501 may be in a different format from controller manipulation data 500 but otherwise identical, e.g., controller manipulation data 500 may be formatted as time-based relative positions and controller manipulation data 501 may be formatted as gestures. Yet further, the controller manipulation data 501 may comprise a portion of the controller manipulation data 500.

Console 660, which is playing the same game, uses the controller manipulation data to show the game and state of controller 150 on its own monitor 600. Along with the controller manipulation data 501, console 200 may also transmit game data 502 if the game data is required or helpful in rendering the game on monitor 600.

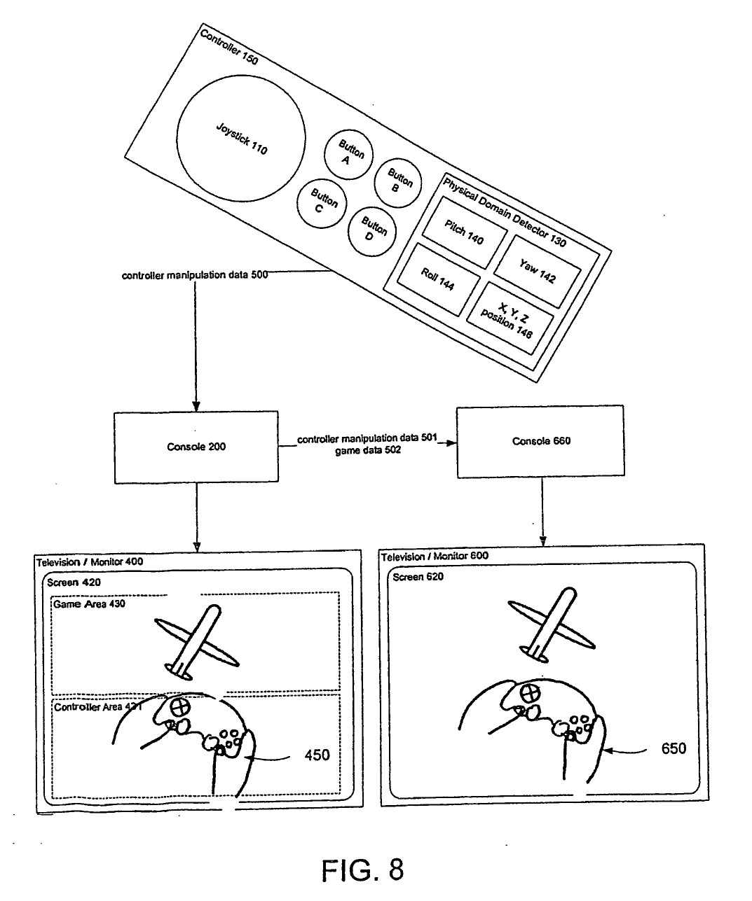

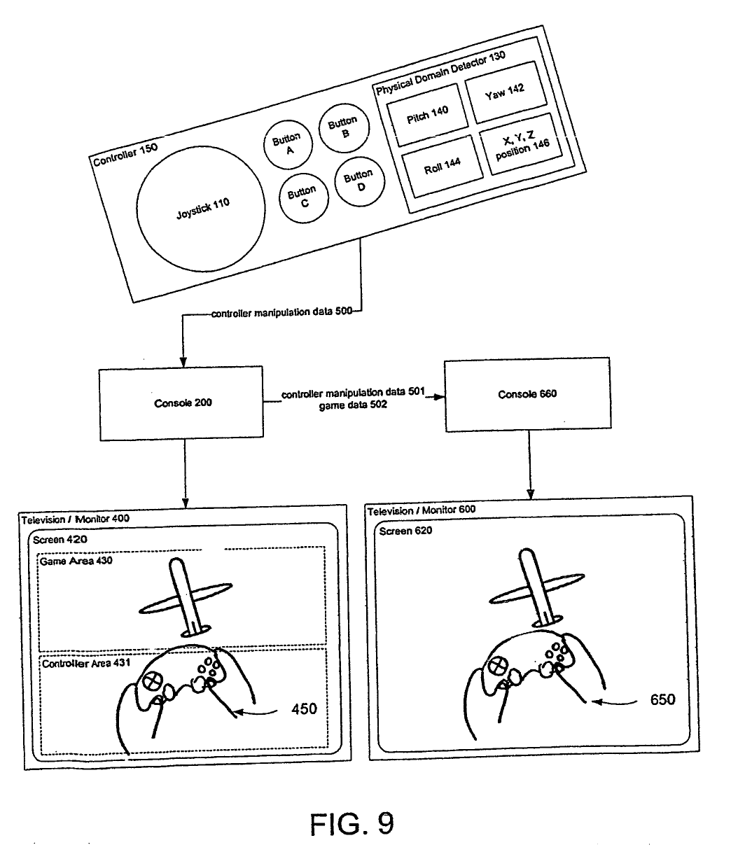

As shown in FIG. 8, when the yaw of controller 150 is manipulated in the physical domain (i.e., the yaw orientation of the controller with respect to the physical world is changed), the yaw detector 142 detects such change and the new yaw angle is reflected in the controller manipulation data 500. If the game uses yaw to manipulate the in-game character, then the change in yaw causes a change in the orientation of the game character as shown in FIG. 8. The change in yaw is also shown in controller graphic 450 rendered on the monitor connected to console 200. The change in yaw is also reflected in the controller manipulation data 501 sent to remote console 660, resulting in a consequent change in yaw position in controller graphic 650 on the monitor 660 connected to second console 660. FIG. 9 illustrates the same effect when the yaw moves in the other direction. While this maneuver may be difficult to describe to another player, it may be easily viewed and imitated.

Thus one aspect of the invention allows one console to show the state of a controller connected to a different console. Moreover, the manipulation of one controller may be rendered in real-time on two different consoles at two different locations.

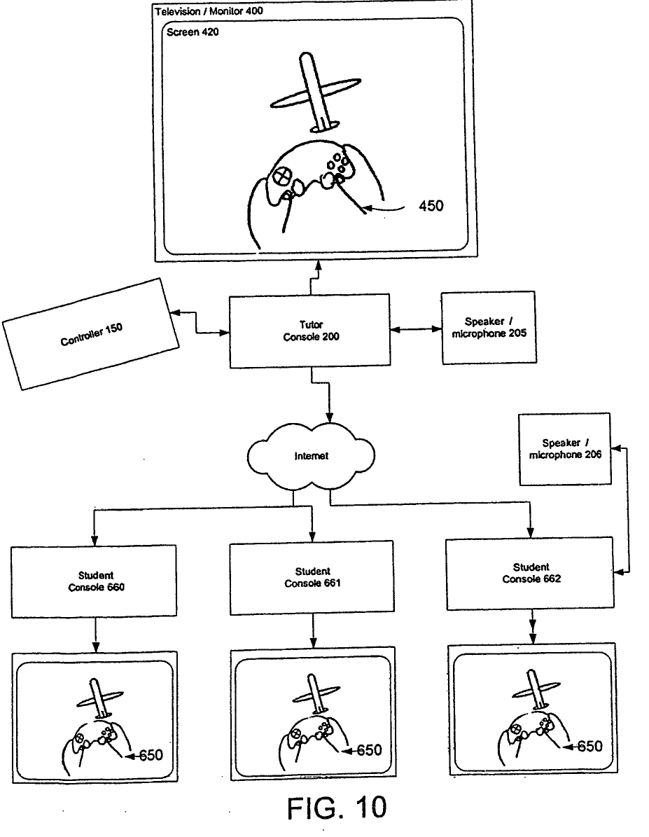

One aspect of the invention provides for a tutorial. In that regard and as shown in FIG. 10, the user at console 200 (hereafter, the “tutor”) may teach the user at console 660 (hereafter, the “student”) how to play a game. As the tutor manipulates the controller 150, the student can watch those manipulations take place on controller graphic 650 on the monitor attached to the student's console.

Accordingly, the student is taught how to play the game. In this aspect, the invention provides for a real-time instruction of how to play a game—the student can watch the tutor play the game in real-time and watch the tutor's manipulation of the control in real-time. In another aspect of the invention, there are multiple student consoles 660-662, all of which receive controller manipulation data from tutor console 200.

There may also be more than one user at a single console. For example, the student consoles may be located at retails stores all over the world, and customers can watch an expert play the game. Such a session would be particularly advantageous in connection with a product rollout, because it allows the user to not only watch the game but also see how it is played. Moreover, by learning how to play the game, the students can increase their enjoyment of the game.

Preferably, the tutor console and student consoles are equipped with speakers and microphones 205-206 to allow the tutor to talk to the students. For example, a student may ask “How do you jump like that?” to which the tutor may answer “By raising my controller above the ground as follows; watch the phantom hands on your screen.”

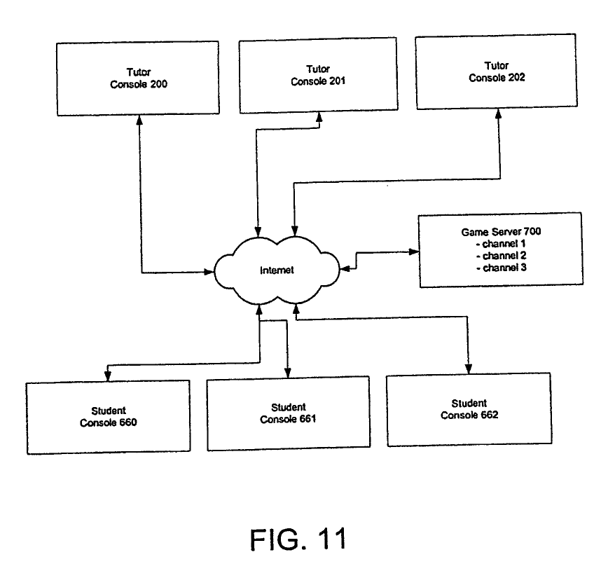

In another aspect of the invention and as shown in FIG. 11, the students can select from multiple tutorial sessions by logging into a web server such as game server 700. For example, the game server 700 may advertise multiple channels where each channel is associated with one or more tutorial sessions offered by the users at tutor consoles 200-202. To join a tutoring session, the student need only click a channel, which then causes the student console to be joined to the game with the requested tutor. The relationship between tutor console and student consoles may be one-to-one, one-to-many or many-to-one. Tutors may be awarded for their efforts, such as being provided with in-game incentives. U.S. Provisional Patent Application No. 60/860,938 describes some in-game incentives, the disclosure of which is hereby incorporated by reference.

To assist with the tutorial aspects or for other reasons, controller manipulation data may be recorded along with other game data. As shown in FIG. 5, data 245 may store the controller manipulation data 246 received from the controller 150 and what happened in the game as a result, such as data 247 representing the position of a game character. The captured controller manipulation data 246 and the character position data 247 are preferably synchronized, thus enabling the consoles to replay and render not only the game action but also the corresponding controller manipulation as well. This allows the student to use the game instructions to replay (and show) the manipulation of the control and the corresponding action in the game. For example, in addition to playing back a touchdown thrown in a football game, the console can display the controller manipulations which resulted in the touchdown. In another aspect of the invention, the game data and corresponding controller manipulation data can be played back in slow motion.

Rather than separately storing and synchronizing the controller manipulation data and game data over time, as well as the game instructions necessary to playback the game data and controller manipulations, the three may be combined and stored as a movie in another aspect of the invention. Alternatively, the played game and controller graphic may be stored as a movie file such as an MPEG file.

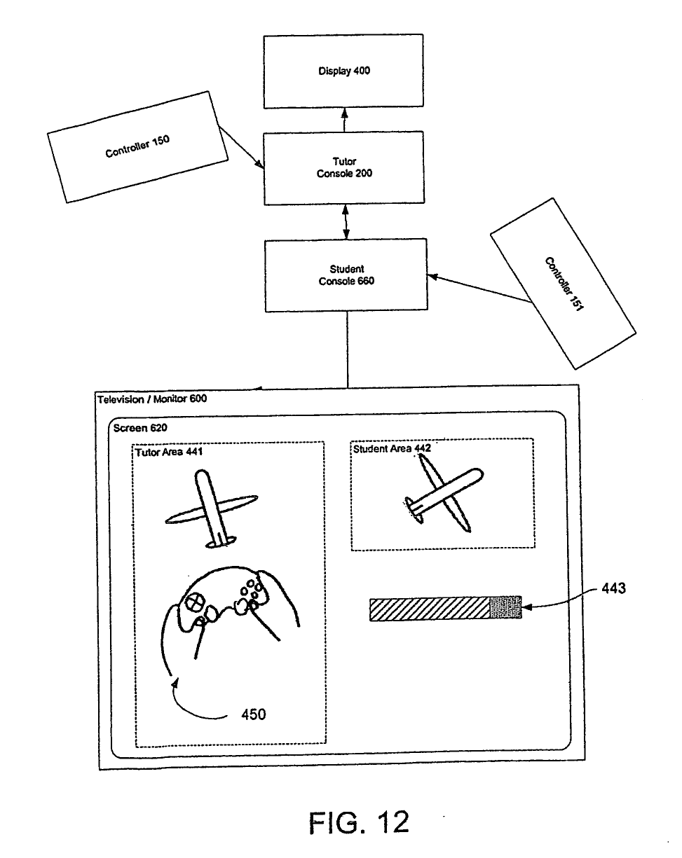

In another aspect of the invention, the student attempts to mimic the tutor as shown in FIG. 12. Controller graphic 450, which corresponds with the tutor's manipulation of its controller 150, is shown on the student's screen 620 as described above. The in-game character responsive to the tutor's movements is also shown in the tutor area 441 of the student's screen. The student's in-game character responsive to the student's manipulation of controller 151 is shown in student area 442, which is preferably shown side-by-side with the tutor's in-game character. The student must try to mimic the actions of the tutor so that the movement of the student's in-game character matches perfectly with the movement of the tutor's in-game character. A feedback graphic such as bar 443 may also be displayed to the student, where the bar's length corresponds with how closely the student is mimicking the tutor. Audio feedback may also be used, such that a sound changes depending on well the student is synchronized with the tutor. Rather than displaying the two characters side-by-side, the student's character may also be overlaid on top of the tutor's character (with or without alpha-blending), so that the student's goal is to keep his or her character directly on top of the tutor's character.

If the controller manipulation data is pre-recorded or calculated on the fly, the tutor may comprise artificial intelligence. For example, instead of watching a live tutor's manipulation of a controller in real-time, the student may watch or respond to a live tutor's pre-recorded controller manipulation data. Alternatively, the student may watch or respond to controller manipulation data generated by a computer.

Although the system is described with respect to video/electronic games, it will be understood by those of skill in the art that the same technology may be applied to many other uses. For example, an aerospace school might employ this technology for pilot training through flight simulation. Accordingly, the examples described should not be construed as limiting or exhaustive. Rather, it is to be understood that the embodiments described are merely illustrative of the principles and applications of the present invention. Therefore, numerous modifications may be made to the illustrative embodiments and other arrangements may be devised without departing from the spirit and scope of the present invention as defined by the appended claims.

1. A method comprising:
receiving controller manipulation data identifying manipulation of a controller,
displaying a controller graphic representing the controller on a first display, the controller graphic visually indicating the manipulation,
displaying, on the first display, other data changed in response to the manipulation of the controller,
transmitting the controller manipulation data for substantially-simultaneous display of a controller graphic on a second display remote from the first display.

2. The method of claim 1 wherein the other data is a character in a game, and position or orientation of the character is changed in response to the manipulation of the controller.

3. The method of claim 1 wherein the controller graphic represents a picture of a controller having buttons.

4. The method of claim 1 wherein the controller manipulation data includes data representing manipulation of controls on the controller and the position or orientation of the controller in the physical domain.

5. The method of claim 4 wherein the position or orientation of the controller comprises one of the following: pitch, yaw, roll or three-dimensional distance.

6. The method of claim 1 further comprising receiving the controller manipulation data and displaying a controller graphic on a second display remote from the first display.

7. The method of claim 1 wherein the controller graphic is displayed on a portion of the screen separate from the portion displaying the other data.

8. A system comprising:
a first processor and first display at a first location,
a first controller including user-operable controls,
a second processor and a second display at a second location,
communication circuits structured to transmit data from the first processor to the second processor,
first instructions executable by the first processor, the instructions comprising: receiving first data representing a user's operation of a user-operable control; rendering an image of the controller based on the first data on the first display, including rendering the operation of the user-operable control; transmitting the identity of the control which was operated, and; sending second data representing the operation of the user-operable control to the second processor,
second instructions executable by the second processor, the instructions comprising: receiving the second data, rendering an image of the first controller based on the second data on the second display, including rendering the operation of the user-operable control.

9. The system of claim 8 wherein the user-operable control comprises a physical domain detector.

10. A system of displaying data comprising:
a tutor system comprising a user-operable controller and a processor;
a plurality of student systems, each student system comprising a processor and a display;
a communication medium between the tutor system and each student system for communicating data relating to user operation of the control from the tutor system to the student system;
whereby each student processor of the student system is arranged to render a visual representation of the first controller on the display based on the communicated data, said display visual representation including an indication of the user operation.

11. The system of claim 10 wherein the communication medium comprises a network.

12. The system of claim 10 wherein the user operation comprises changing the position or orientation of the controller with respect to the tutor console.

13. The system of claim 10 wherein the tutor console and at least one student console further comprise a microphone and speaker for orally conveying information between the users of the consoles.

14. The system of claim 10 wherein the student consoles display the visual representation of the first controller substantially simultaneously with the other student consoles.

15. A method of displaying the position of a controller comprising:
receiving, at a first console, manipulation data from a first controller connected to the first console,
receiving, at the first console, manipulation data from a second controller connected to a second console,
calculating a value representing the difference between the manipulation data from the first controller and the second controller, and
rendering a difference value.

16. The method of claim 15 wherein the step of receiving manipulation data from a second controller comprises receiving the manipulation data from over a network.

17. The method of claim 15 wherein the step of rendering the difference value comprises rendering a graphic whose appearance changes based on the amount of the difference value.

18. The method of claim 15 wherein the step of rendering the difference value comprises rendering a sound which changes based on the amount of the difference value.

19. The method of claim 15 further comprising
displaying first game data and second game data;
modifying the first game data in accordance with the data representing manipulation of the first controller;
modifying the second game data in accordance with the data representing manipulation of the second controller;
displaying the first game data and the second game data on the same screen.

20. The method of claim 19 wherein the first game data represents a game character and the second game data represents a second game character.
